(19) United States
(12) Patent Application Publication
(10) Pub. No.: US 2005/0233641 A1
(43) Pub. Date: Oct. 20, 2005

(54) Shield structure of electronic device

(76) Inventors: Atsushi Nakano, Atsugi-shi (JP); Hayato Shibano, Atsugi-shi (JP)

Correspondence Address: WHITHAM, CURTIS & CHRISTOFFERSON, P.C., 11491 SUNSET HILLS ROAD, SUITE 340, RESTON, VA, 20190, US

(21) Appl. No.: 11/050,855

(22) Filed: Jan. 27, 2005

(30) Foreign Application Priority Data
Apr. 15, 2004 (JP) 2004-120535

(51) Int. Cl. H01R 13/648

(52) U.S. Cl. 439/608

(57) ABSTRACT

The present invention relates to shield structure of electronic device in which a base board on which high-frequency circuit blocks are mounted is housed in a conductive case thereby to be shielded. A notch is provided for the base board, and a cut-down piece is provided for the conductive case correspondingly to the notch. Hereby, erroneous insertion in which the insertion direction of the base board is wrong can be eliminated. Further, the insertion working of the base board can be readily performed, and productivity can be improved. By removing the useless space of the base board, high-density mounting can be realized, and the whole of the base board has the sufficient shield effect.

### BACKGROUND OF THE INVENTION

1. Field of the Invention

The present invention relates to shield structure of electronic device, for example, in a RF unit for codeless telephone, which shields a base board with a conductive case

2. Description of the Related Art

For example, in a RF unit for codeless telephone, in order to remove a jamming signal or improve unnecessary radiation, a base board on which a high frequency circuit block is mounted has been housed in a conductive case or cover thereby to be shielded. Further, it is required that the whole of the electronic device is not only shielded but also the electronic device is finely shielded for each circuit block in order to suppress internal local oscillation leakage and external noise.

Regarding the conventional shield structure of electronic device, this type of electronic device is constituted basically by housing a printed wiring board on which various circuit parts constituting a high frequency circuit block are mounted, in a conductive shield case. Here, on the printed wiring board, a transmission-side local oscillation circuit block and a reception-side local oscillation circuit block are mounted, and internal shields for shielding these blocks are provided so as to partition the inside of the shield case into plural sections. By this internal shield, for example, the transmission-side local oscillation circuit block is shielded from other circuit parts.

In the above electronic device, as attachment structure of the base board to the shield case, various structure have been proposed (refer to, for example, JP-A-2000-91779). In the invention described in Patent Reference 1, a leg part that protrudes downward is provided for a lower end part of a shield chassis, an attachment hole into which the leg part provided for the shield chassis is inserted is provided for a base board, and the leg is fitted into the attachment hole, whereby the shield chassis is built into the base board.

In case that the base board is attached to the above shield case, it is necessary to pay an attention to an attachment direction. For example, in case that the shape of the base board is up-down and left-right symmetrical (rectangle), even if the insertion direction of the base board is wrong, it is difficult to judge whether the insertion direction is wrong or not. In case that there is the partition plate in the shield case, when the insertion direction of the base board is wrong, the predetermined partition state is not obtained, and the internal shield becomes insufficient, so that there is fear of occurrence of such an obstacle that internal local oscillation leakage cannot be suppressed fully.

As the invention described in the Patent Reference 1, in case that the leg part that protrudes downward is provided for the lower end part of the shield chassis, the attachment hole into which the leg part provided for the shield chassis is inserted is provided for the base board, and the leg is fitted into the attachment hole, for example, by contriving the shapes of the leg part and the attachment hole, and their setting positions, the erroneous insertion of the base board can be prevented to a certain degree. However, this attachment structure has such defects that attachment working is complicated, useless space is required in the peripheral part of the base board, and both sides of the base board cannot obtain sufficient shield effect.

### SUMMARY OF THE INVENTION

The invention has been proposed in order to solve such the disadvantages in the conventional shield structure. An object of the invention is to shield structure of electronic device in which the insertion direction of a base board can be judged accurately, and insertion working of the base board can be performed smoothly.

In order to achieve the above object, shield structure of electronic device according to the invention in which a base board on which a high-frequency circuit block is mounted is housed in a conductive case thereby to be shielded is characterized in that a notch is provided for the base board, and a cut-down piece is provided for the conductive case correspondingly to the notch.

In the shield structure of the invention, the notch provided for the base board, and the cut-down piece provided for the conductive case function as marks, so that erroneous insertion in which the insertion direction of the base board is erroneous is eliminated. Further, as described before, since the recess provided for the base board, and the cut-down piece provided for the conductive case function as the marks, the insertion working of the base board is performed smoothly.

Further, compared with the structure in which the leg part provided for the shield chassis is inserted into the attachment hole provided in the base board, the attachment working is easy, and the useless space is required in the peripheral part of the base board. Further, since the base board is housed in the conductive case, the whole of the base board has the sufficient shield effect.

According to the shield structure of electronic device of the invention, by only addition of the simple constitution, the erroneous insertion in which the insertion direction of the base board is erroneous can be eliminated. Further, the insertion working of the base board can be readily performed, so that productivity can be improved. Further, according to the invention, the useless space for the base board can be removed, so that high-density mounting can be realized. Further, the sufficient shield effect for the whole of the base board can be obtained.

### BRIEF DESCRIPTION OF THE DRAWINGS

FIG. 1 is an exploded perspective view showing an attachment state of a printed wiring board to a shield case.

### DESCRIPTION OF THE PREFERRED EMBODIMENTS

Shield structure of electronic device to which the invention is applied will be described in detail below with reference to drawings.

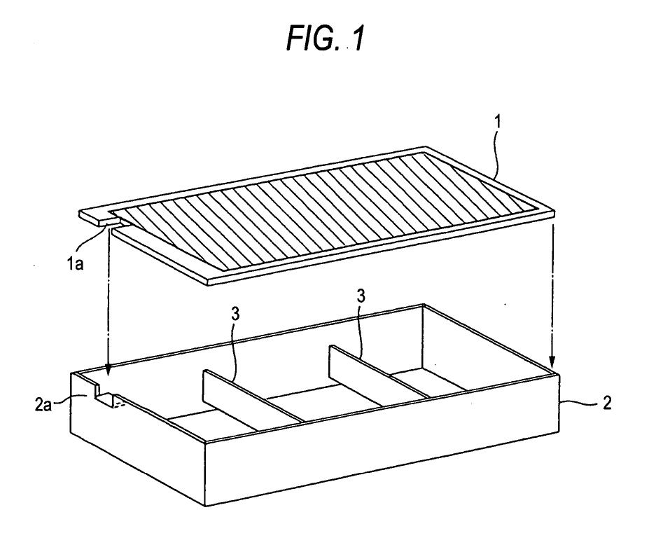

FIG. 1 shows shield structure of electronic device in this embodiment. The electronic device in the embodiment is, for example, a transmission RF module or a reception RF module for a minicomponent or a microcomponent, in which a printed wiring board 1 on which various circuit parts constituting high frequency circuit blocks are mounted is housed in a conductive shield case 2, and space in the shield case 2 is partitioned into plural sections by internal shields 3.

On the printed wiring board 1, a transmission-side local oscillation circuit block and a reception-side local oscillation circuit block are mounted. Here, the internal shields 3 partition the inside of the shield case 2 into the plural sections, and shield, for example, the reception-side local oscillation circuit block and the transmission-side local oscillation circuit block, thereby to prevent these blocks from influencing other regions (other circuit blocks) of the printed wiring board 1.

In the thus constructed shield structure, the printed wiring board 1 that is a base board is formed separately from the shield case 2 that is a conductive case. By attaching the printed wiring board 1 in the predetermined position of the shield case 2, they are assembled.

In case that the shape of the printed wiring board 1 is up-down and left-right symmetrical, for example, rectangle, possibility of work's attaching the printed wiring board 1 to the shield case 2 in the wrong direction is high. If the printed wiring board 1 is attached to the shield case 2 in the wrong direction, each section partitioned by the internal shields 3 differs from the design of the printed wiring board 1, so that the sufficient internal shield effect is not obtained.

Therefore, in the invention, a notch 1 a is provided for the printed wiring board 1, a cut-down piece 2a is provided also for the shield case 2, and these are used as marks, thereby to prevent the attachment of the printed wiring board 1 to the shield case 2 in the wrong direction.

The notch 1a provided for the printed wiring board 1 is formed by cutting some portion of a peripheral edge of the printed wiring board 1. Further, the notch 1 does not need to have the particularly complicated shape but may be simply recess-shaped.

On the other hand, the cut-down piece 2a provided also for the shield case 2 does not need to have the special shape, but may have the shape of a minute piece protruding toward the inside of the shield case 2. Here, parallel cuts are made into a side wall of the shield case 2 at the predetermined distance, and the side wall portion interposed between these cuts is bent inward, whereby the cut-down piece 2a is formed.

Any of the notch 1a provided for the printed wiring board 1 and the cut-down piece 2a provided also for the shield case 2 can be readily confirmed visually. Accordingly, the worker, with these notch 1a and cut-down piece 2a as marks, can insert the printed wiring board 1 into the shield case 2, and can attach the printed wiring board 1 to the shield case 2 in the correct insertion direction, so that the erroneous insertion can be eliminated. Further, when the printed wiring board 1 is inserted into the shield case 2, the cut-down piece 2a is inserted into the notch 1a, and the printed wiring board 1 is pressed and supported by elastic power of the metal plate. Therefore, the attachment state of the printed wiring board 1 to the shield case 2 is also stabilized.

It is sufficient that each of the notch 1a and the cut-down piece 2a is provided at at least one place of the surroundings of the print circuit base 1 or an opening part of the shield case. However, these notches and cut-down pieces may be at the plural places, whereby the erroneous insertion can be prevented more surely. In this case, it is necessary to avoid arranging these notches 1a and cut-down pieces 2a in point-symmetrical positions. In case that the plural notches 1a and cut-down pieces 2a are arranged in the point-symmetrical positions, for example, also in a state in which the printed wiring board 1 is turned at 180°, the position of the notch 1a coincides with the position of the cut-down piece 2a, so that the object of preventing the erroneous insertion cannot be achieved.

1. Shield structure of electronic device, comprising:
a base board, on which a high-frequency circuit block is mounted;
a conductive case, in which the base board is housed so as to be shielded, wherein:
a notch is provided with the base board; and
a cut-down piece is provided with the conductive case correspondingly to the notch.

2. The shield structure of electronic device according to claim 1, wherein the notch and the cut-down piece are provided in plural places.

3. The shield structure of electronic device according to claim 1, wherein the shape of the base board is up-down and left-right symmetrical.

4. The shield structure of electronic device according to claim 1, wherein a partition plate is provided inside the conductive case.
